(19) United States
(12) Patent Application Publication
(10) Pub. No.: US 2025/0185111 A1
(43) Pub. Date: Jun. 5, 2025

(54) DISCONTINUOUS TRANSMISSION CYCLE COMMUNICATION SCHEDULING

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US); Ahmed Attia ABOTABL, San Diego, CA (US); Muhammad Sayed Khairy ABDELGHAFFAR, San Jose, CA (US)

(21) Appl. No.: 18/841,771

(22) PCT Filed: Feb. 1, 2023
(86) PCT No.: PCT/US2023/061780

§ 371 Date: Aug. 27, 2024

(30) Foreign Application Priority Data
Apr. 21, 2022 (GR) 20220100336

(51) Int. Cl. H04W 76/28

(52) U.S. Cl. CPC H04W 76/28

(57) ABSTRACT

Various aspects of the present disclosure generally relate to wireless communication. In some aspects, a user equipment (UE) may receive a wake-up indication, for a discontinuous transmission (DTX) cycle period, that indicates to perform a transmission associated with at least one of scheduling, energy transfer, or relaying. The UE may perform the transmission during the DTX cycle period. Numerous other aspects are described.

### CROSS-REFERENCE TO RELATED APPLICATION

This patent application claims priority to Greek Patent Application No. 20220100336, filed on Apr. 21, 2022, entitled “DISCONTINUOUS TRANSMISSION CYCLE COMMUNICATION SCHEDULING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for discontinuous transmission cycle communication scheduling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of a discontinuous reception configuration, in accordance with the present disclosure.

FIG. 7 is a diagram illustrating an example associated with discontinuous transmission (DTX) cycle communication scheduling, in accordance with the present disclosure.

FIG. 8 is a diagram illustrating an example associated with DTX cycle periods, in accordance with the present disclosure.

FIG. 9 is a diagram illustrating an example process associated with DTX cycle communication scheduling, in accordance with the present disclosure.

FIG. 10 is a diagram illustrating an example process associated with DTX cycle communication scheduling, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### SUMMARY

Some aspects described herein relate to a method of wireless communication performed by a user equipment (UE). The method may include receiving a wake-up indication, for a discontinuous transmission (DTX) cycle period, that indicates to perform a transmission associated with at least one of scheduling, energy transfer, or relaying. The method may include performing the transmission during the DTX cycle period.

Some aspects described herein relate to a method of wireless communication performed by a network node. The method may include receiving DTX cycle information from a UE that indicates one or more active DTX cycle periods and one or more inactive DTX cycle periods. The method may include transmitting a wake-up indication, for an active DTX cycle period of the one or more active DTX cycle periods, that indicates for the UE to perform a transmission associated with at least one of scheduling, energy transfer, or relaying.

Some aspects described herein relate to an apparatus for wireless communication performed by a UE. The apparatus may include a memory and one or more processors, coupled to the memory. The one or more processors may be configured to receive a wake-up indication, for a DTX cycle period, that indicates to perform a transmission associated with at least one of scheduling, energy transfer, or relaying. The one or more processors may be configured to perform the transmission during the DTX cycle period.

Some aspects described herein relate to an apparatus for wireless communication performed by a network node. The apparatus may include a memory and one or more processors, coupled to the memory. The one or more processors may be configured to receive DTX cycle information from a UE that indicates one or more active DTX cycle periods and one or more inactive DTX cycle periods. The one or more processors may be configured to transmit a wake-up indication, for an active DTX cycle period of the one or more active DTX cycle periods, that indicates for the UE to perform a transmission associated with at least one of scheduling, energy transfer, or relaying.

Some aspects described herein relate to a non-transitory computer-readable medium that stores a set of instructions for wireless communication by a UE. The set of instructions, when executed by one or more processors of the UE, may cause the UE to receive a wake-up indication, for a DTX cycle period, that indicates to perform a transmission associated with at least one of scheduling, energy transfer, or relaying. The set of instructions, when executed by one or more processors of the UE, may cause the UE to perform the transmission during the DTX cycle period.

Some aspects described herein relate to a non-transitory computer-readable medium that stores a set of instructions for wireless communication by a network node. The set of instructions, when executed by one or more processors of the network node, may cause the network node to receive DTX cycle information from a UE that indicates one or more active DTX cycle periods and one or more inactive DTX cycle periods. The set of instructions, when executed by one or more processors of the network node, may cause the network node to transmit a wake-up indication, for an active DTX cycle period of the one or more active DTX cycle periods, that indicates for the UE to perform a transmission associated with at least one of scheduling, energy transfer, or relaying.

Some aspects described herein relate to an apparatus for wireless communication. The apparatus may include means for receiving a wake-up indication, for a DTX cycle period, that indicates to perform a transmission associated with at least one of scheduling, energy transfer, or relaying. The apparatus may include means for performing the transmission during the DTX cycle period.

Some aspects described herein relate to an apparatus for wireless communication. The apparatus may include means for receiving DTX cycle information from a UE that indicates one or more active DTX cycle periods and one or more inactive DTX cycle periods. The apparatus may include means for transmitting a wake-up indication, for an active DTX cycle period of the one or more active DTX cycle periods, that indicates for the UE to perform a transmission associated with at least one of scheduling, energy transfer, or relaying.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

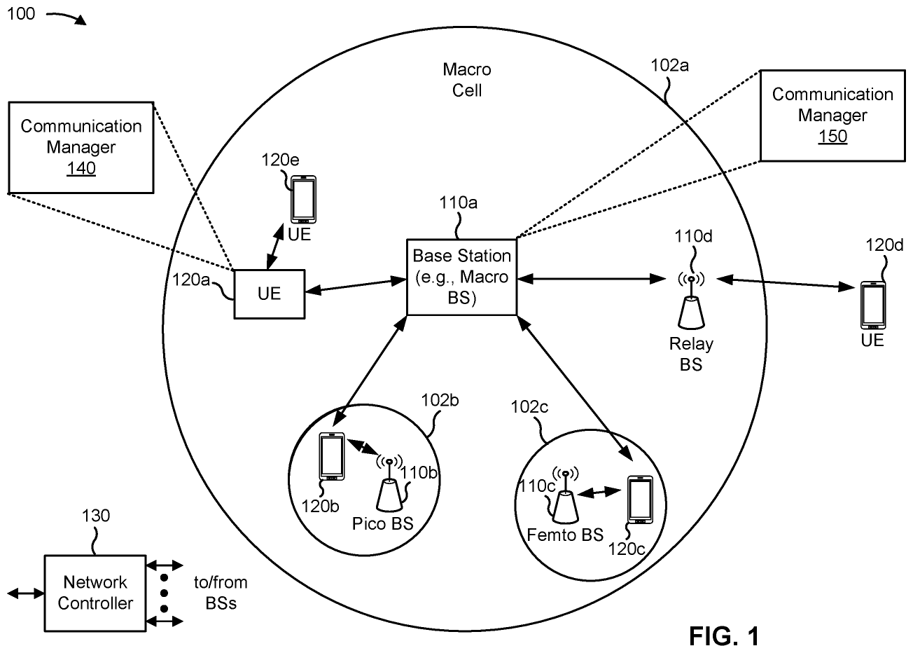

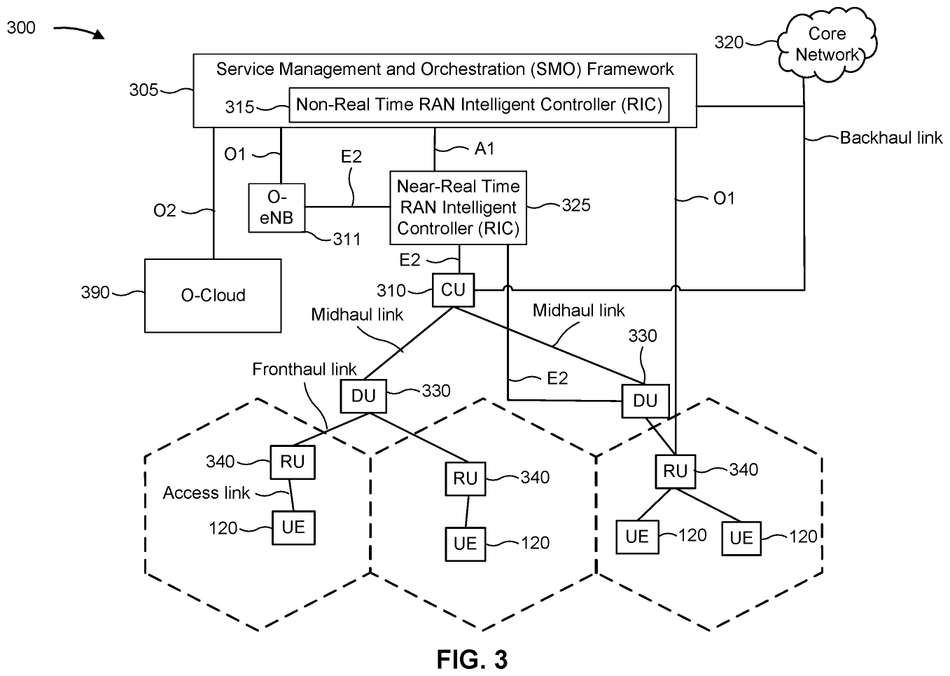

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although depicted as an integral unit in FIG. 1, aspects of the disclosure are not so limited. In some other aspects, the functionality of the base station 110 may be disaggregated according to an open radio access network (RAN) (O-RAN) architecture or the like, which is described in more detail in connection with FIG. 3. Each base station 110 may provide communication coverage for a geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a wake-up indication, for a discontinuous transmission (DTX) cycle period, that indicates to perform a transmission associated with at least one of scheduling, energy transfer, or relaying; and perform the transmission during the DTX cycle period. Additionally, or alternatively, the communication manager 140 may perform one or more other operations described herein.

In some aspects, the base station 110 may include a communication manager 150. As described in more detail elsewhere herein, the communication manager 150 may receive DTX cycle information from a UE that indicates one or more active DTX cycle periods and one or more inactive DTX cycle periods; and transmit a wake-up indication, for an active DTX cycle period of the one or more active DTX cycle periods, that indicates for the UE to perform a transmission associated with at least one of scheduling, energy transfer, or relaying. Additionally, or alternatively, the communication manager 150 may perform one or more other operations described herein.

As indicated above, FIG. 1 is provided as an example. Other examples may differ from what is described with regard to FIG. 1.

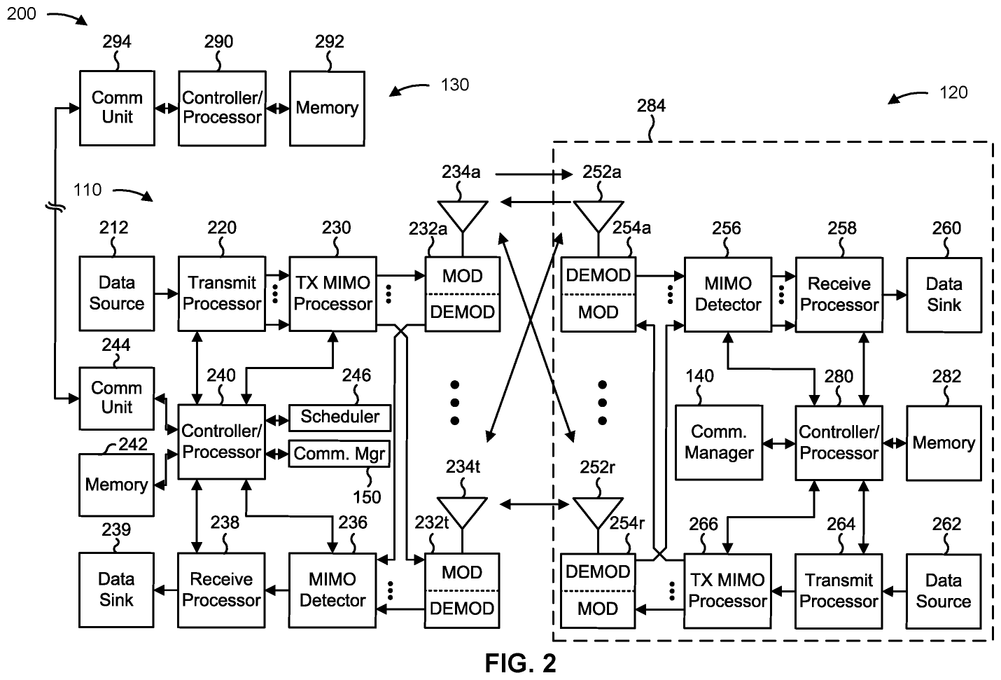

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna army may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

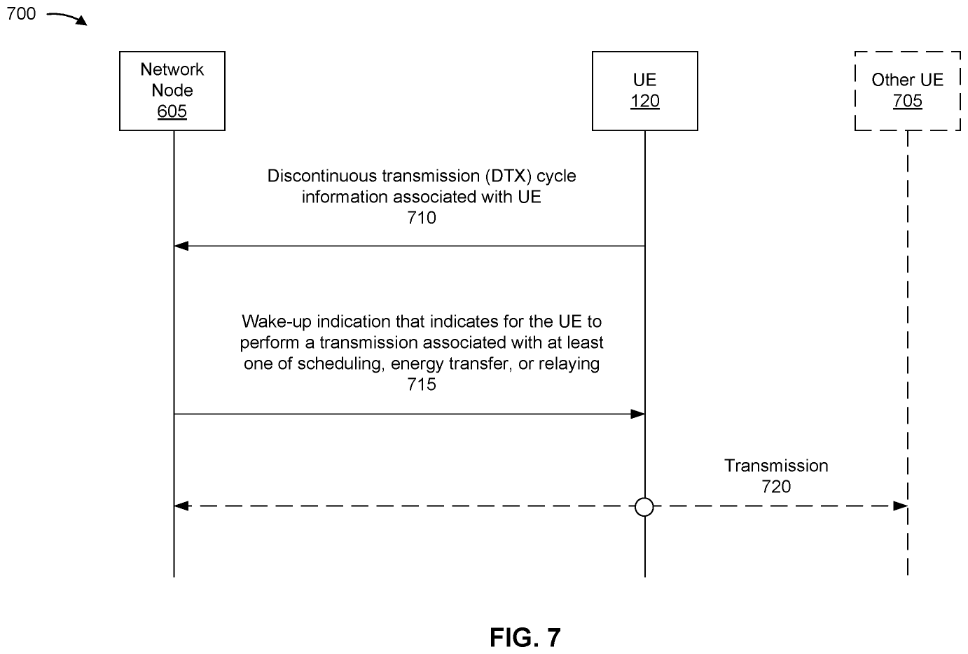

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

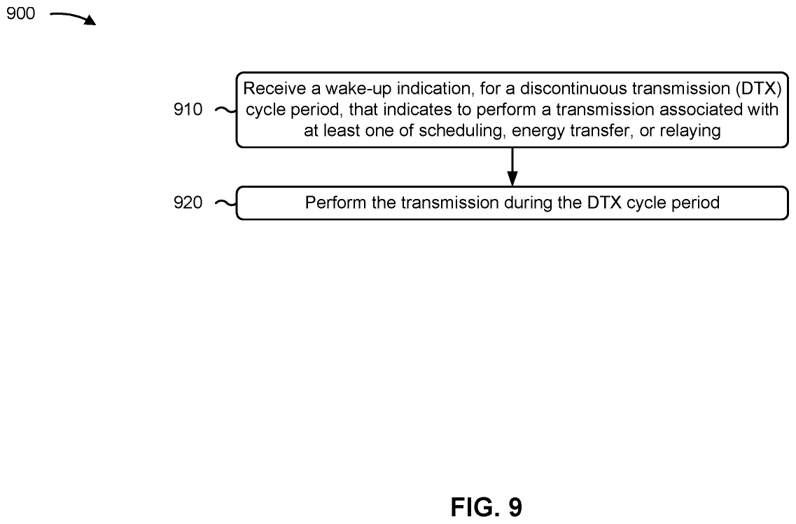

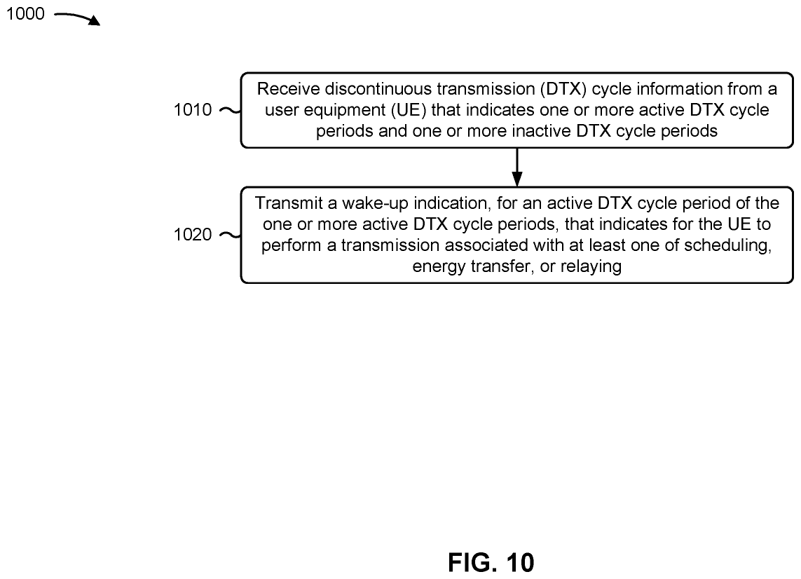

The controller/processor 240 of the base station 110, the controller/processor 280 of the UE 120, and/or any other component(s) of FIG. 2 may perform one or more techniques associated with DTX cycle communication scheduling, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE includes means for receiving a wake-up indication, for a DTX cycle period, that indicates to perform a transmission associated with at least one of scheduling, energy transfer, or relaying; and/or means for performing the transmission during the DTX cycle period. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for receiving DTX cycle information from a UE that indicates one or more active DTX cycle periods and one or more inactive DTX cycle periods; and/or means for transmitting a wake-up indication, for an active DTX cycle period of the one or more active DTX cycle periods, that indicates for the UE to perform a transmission associated with at least one of scheduling, energy transfer, or relaying. In some aspects, the means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

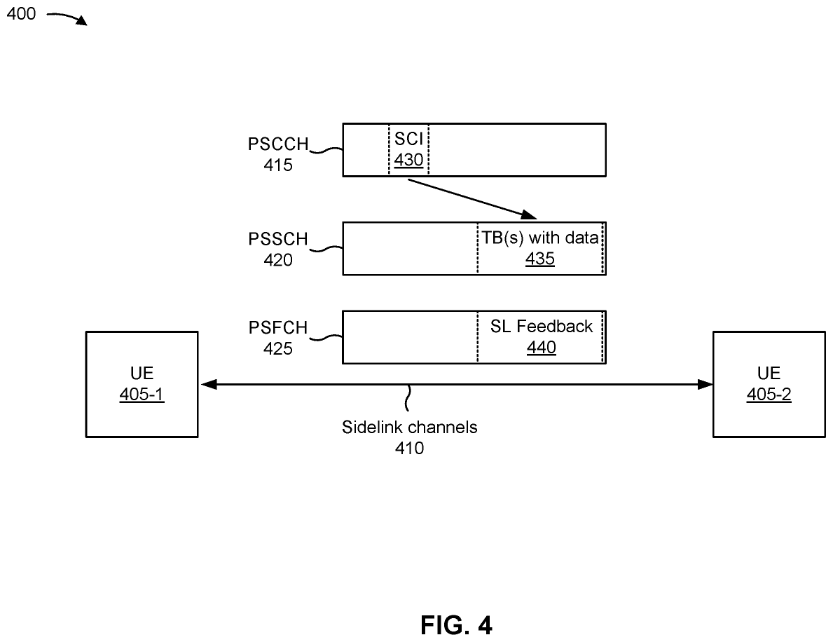

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel. The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a base station 110. For example, the UE 405 may receive a grant (e.g., in downlink control information (DCI) or in an RRC message, such as for configured grants) from the base station 110 for sidelink channel access and/or scheduling. In some aspects, a UE 405 may operate using a transmission mode (e.g., Mode 2) where resource selection and/or scheduling is performed by the UE 405 (e.g., rather than a base station 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

In some cases, the UE 405-1 may be configured to perform sidelink scheduling, sidelink energy transfer, or sidelink relaying for the UE 405-2 via the sidelink channels 410. In some cases, the UE 405-1 may perform the sidelink scheduling, sidelink energy transfer, or sidelink relaying according to a DTX cycle.

As indicated above, FIG. 4 is provided as an example. Other examples may differ from what is described with respect to FIG. 4.

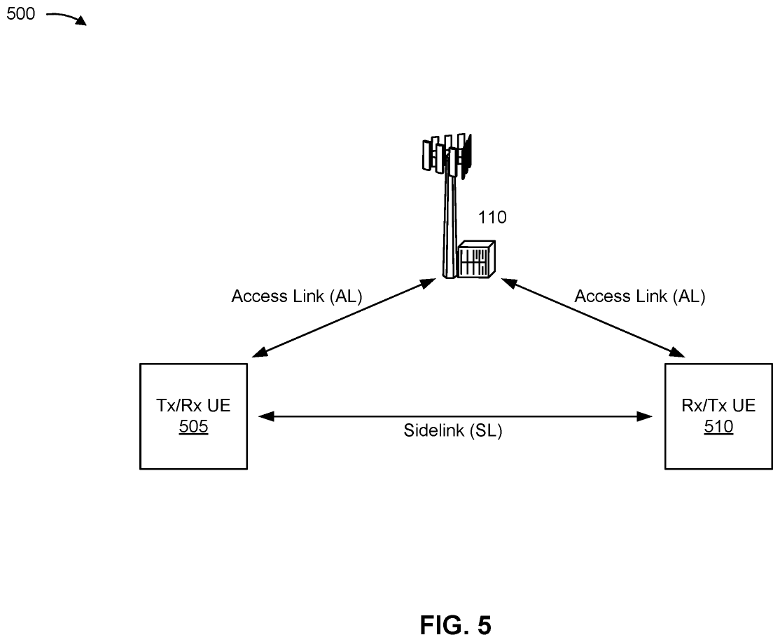

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a base station 110 may communicate with the Tx/Rx UE 505 via a first access link. Additionally, or alternatively, in some sidelink modes, the base station 110 may communicate with the Rx/Tx UE 510 via a second access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

In some cases, the UE 505 may be configured to perform sidelink scheduling, sidelink energy transfer, or sidelink relaying for the UE 510. In some cases, the UE 505 may perform the sidelink scheduling, sidelink energy transfer, or sidelink relaying according to a DTX cycle.

As indicated above, FIG. 5 is provided as an example. Other examples may differ from what is described with respect to FIG. 5.

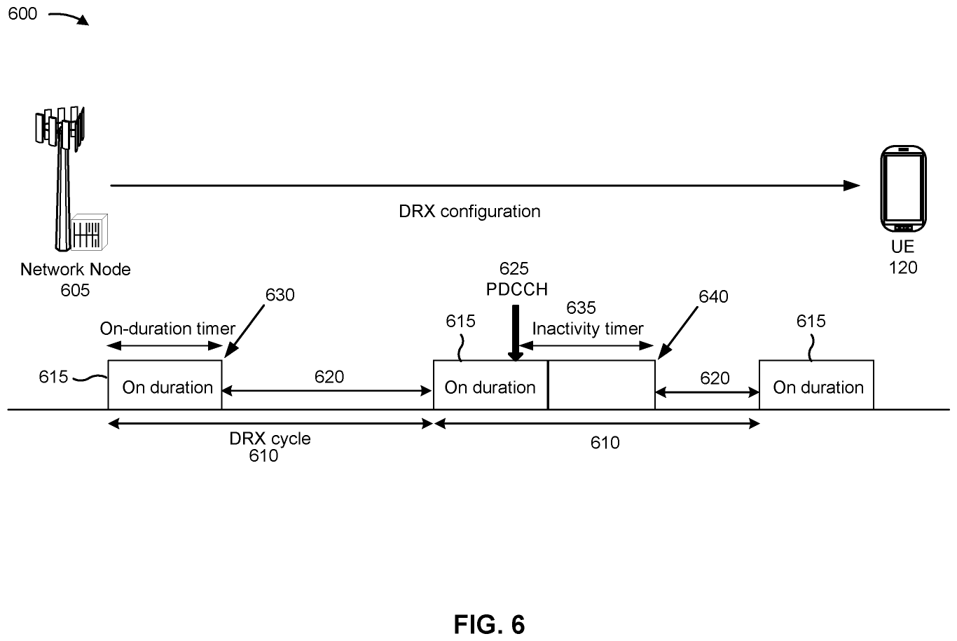

FIG. 6 is a diagram illustrating an example 600 of a discontinuous reception (DRX) configuration, in accordance with the present disclosure. The UE 120 may communicate with a network node, such as the network node 605. The network node 605 may include some or all of the features of the base station 110, the CU 310, the DU 330, and/or the RU 340.

As shown in FIG. 6, a base station 110 may transmit a DRX configuration to a UE 120 to configure a DRX cycle 610 for the UE 120. A DRX cycle 610 may include a DRX on duration 615 (e.g., during which a UE 120 is awake or in an active state) and an opportunity to enter a DRX sleep state 620. As used herein, the time during which the UE 120 is configured to be in an active state during the DRX on duration 615 may be referred to as an active time, and the time during which the UE 120 is configured to be in the DRX sleep state 620 may be referred to as an inactive time. As described below, the UE 120 may monitor a PDCCH during the active time, and the UE 120 may refrain from monitoring the PDCCH during the inactive time.

During the DRX on duration 615 (e.g., the active time), the UE 120 may monitor a downlink control channel (e.g., a PDCCH), as shown by reference number 625. For example, the UE 120 may monitor the PDCCH for DCI pertaining to the UE 120. If the UE 120 does not detect and/or successfully decode any PDCCH communications intended for the UE 120 during the DRX on duration 615, then the UE 120 may enter the sleep state 620 (e.g., for the inactive time) at the end of the DRX on duration 615, as shown by reference number 630. In this way, the UE 120 may conserve battery power and reduce power consumption. As shown, the DRX cycle 610 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 635 (e.g., which may extend the active time). The UE 120 may start the DRX inactivity timer 635 at a time at which the PDCCH communication is received (e.g., in a TTI in which the PDCCH communication is received, such as a slot or a subframe). The UE 120 may remain in the active state until the DRX inactivity timer 635 expires, at which time the UE 120 may enter the sleep state 620 (e.g., for the inactive time), as shown by reference number 640. During the duration of the DRX inactivity timer 635, the UE 120 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 120 may restart the DRX inactivity timer 635 after each detection of a PDCCH communication for the UE 120 for an initial transmission (e.g., but not for a retransmission). By operating in this manner, the UE 120 may conserve battery power and reduce power consumption by entering the sleep state 620.

In some cases, the network node 605 may transmit, and the UE 120 may receive, a wake-up indication, such as a wake-up signal (WUS), before or at the beginning of an active DRX cycle period (e.g., a DRX on duration). The wake-up indication may be used by the network node 605 to indicate for the UE 120 wake up during the next active period (e.g., to prepare for data reception). In some cases, a wake-up indication payload may indicate for the UE 120 to wake-up or continue sleeping. If the UE 120 does not decode the payload (e.g., is not able to decode the payload), the UE 120 may operate according to a default configuration, such as by defaulting to an active state (a wake state) or an inactive state (a sleep state).

The UE 120 may be configured to perform a sidelink transmission to one or more other devices. In some cases, the sidelink transmission may include sidelink scheduling. For example, the UE 120 may instruct a first device to transmit information to a second device at a certain time. In some cases, the sidelink transmission may include energy signal transmission. For example, the UE 120 may be able to charge an IoT device based at least in part on the UE 120 being in close proximity to the IoT device and having a larger charging capacity than the IoT device. This may reduce the transmit chain power and the power needed for RF adjustments. In some cases, the sidelink transmission may include sidelink relaying. For example, the UE 120 may be configured to relay a communication between the one or more other devices, or from the network node 605 to the one or more other devices.

In some cases, the UE 120 may be configured to perform transmissions (e.g., sidelink or radio link transmissions) according to a DTX cycle. For example, the UE 120 may transmit information during an active state of the DTX cycle, but the UE 120 may not transmit information during an inactive state of the DTX cycle. However, the network node 605 may not be configured with the DTX cycle information associated with the UE 120. In this case, the network node 605 may schedule one or more other communications (e.g., uplink, downlink, or sidelink) during an inactive state of the DTX cycle. This may disrupt the energy saving capabilities of the UE 120. Additionally, or alternatively, the one or more other communications scheduled by the network node 605 may interfere with the DTX cycle transmissions. This may result in one or more of the communications interfering with the DTX communications.

Techniques and apparatuses are described herein for DTX cycle communication scheduling. In some aspects, the UE 120 may transmit, and the network node 605 may receive, DTX cycle information that indicates one or more active DTX cycle periods and one or more inactive DTX cycle periods. The network node 605 may transmit, and the UE 120 may receive, a wake-up indication, for a DTX cycle period, that indicates for the UE 120 to perform a transmission associated with at least one of scheduling, energy transfer, or relaying. The transmission may be a sidelink transmission (PC5) associated with sidelink scheduling, sidelink energy transfer, or sidelink relaying, or may be a radio link transmission (Uu) associated with radio link scheduling, radio link energy transfer, or radio link relaying. The UE 120 may perform the transmission during the DTX cycle period.

As described herein, the network node 605 may not be configured with DTX cycle information associated with the UE 120 performing transmissions, such as scheduling, energy transfer, or relaying. This may result in disrupted energy saving capabilities and/or interfering communications. Using the techniques and apparatuses described herein, the UE 120 may transmit DTX cycle information to the network node 605 that indicates one or more active DTX cycle periods and one or more inactive DTX cycle periods. This may enable the network node 605 to schedule the UE 120 to perform the transmissions during the one or more active DTX cycle periods, and not during the one or more inactive DTX cycle periods. Accordingly, energy saving capabilities of the UE 120 may be improved, and the likelihood of interfering communications may be reduced.

As indicated above, FIG. 6 is provided as an example. Other examples may differ from what is described with respect to FIG. 6.

FIG. 7 is a diagram illustrating an example 700 of DTX cycle communication scheduling, in accordance with the present disclosure. The UE 120 may communicate with the network node 605. The UE 120 and/or the network node 605 may communicate with another UE, such as the other UE 705. The other UE 705 may include some or all of the features of the UE 120. In some aspects, the other UE 705 may be a device that has reduced or limited capabilities, such as an IoT device.

As shown in connection with reference number 710, the UE 120 may transmit, and the network node 605 may receive, DTX cycle information associated with the UE 120. The DTX cycle information may indicate one or more active DTX cycle periods associated with the DTX cycle, and one or more inactive DTX cycle periods associated with the DTX cycle. The one or more active DTX cycle periods may correspond to periods of time at which the UE 120 may perform transmissions. For example, the UE 120 may indicate that the UE 120 is capable of performing scheduling, energy transfer, and/or relaying during the one or more active DTX cycle periods. Alternatively, the one or more inactive DTX cycle periods may correspond to periods of time at which the UE 120 may not perform transmissions (e.g., sidelink or radio link transmissions). For example, the UE 120 may be configured to enter a sleep state, or to otherwise conserve energy, during the one or more inactive DTX cycle periods.

In some aspects, the network node 605 may perform dynamic antenna or bandwidth adaptation for communications with the UE 120 (e.g., since uplink activity may determine downlink adaptation). In some aspects, the network node 605 may perform the dynamic antenna or bandwidth adaptation based at least in part on receiving the DTX cycle information from the UE 120.

As shown in connection with reference number 715, the network node 605 may transmit, and the UE 120 may receive, a wake-up indication that indicates for the UE 120 to perform the transmission associated with at least one of the scheduling, the energy transfer, or the relaying. In some aspects, the wake-up indication may be a WUS or may include a WUS. The wake-up indication may indicate for the UE 120 to perform the transmission during one or more of the active DTX cycle periods.

In some aspects, the wake-up indication may indicate for the UE 120 to perform one or more sidelink transmissions (e.g., via the PC5 interface) during one or more of the active DTX cycle periods. For example, the wake-up indication may indicate for the UE 120 to perform sidelink scheduling, sidelink energy transfer, and/or sidelink relaying during an active DTX cycle period. In some aspects, the wake-up indication may indicate for the UE 120 to perform one or more radio link transmissions (e.g., via the Uu interface) during one or more of the active DTX cycle periods. For example, the wake-up indication may indicate for the UE 120 to perform radio link scheduling, radio link energy transfer, and/or radio link relaying during an active DTX cycle period. In some aspects, the wake-up indication may indicate for the UE 120 to perform one or more sidelink transmissions and one or more radio link transmissions.

In some aspects, transmitting the wake-up indication may include transmitting DCI that includes the wake-up indication. For example, the wake-up indication may be included in one or more bits of the DCI and/or using a DCI format (e.g., DCI 0_1). In some aspects, the wake-up indication may include a radio network temporary identifier (RNTI) or may include an indication of one or more control resource sets (e.g., CORESETs).

In some aspects, the UE 120 may transmit an indication of a duration of the DTX cycle or a duration of a DTX cycle period (e.g., an active DTX cycle period). For example, the UE 120 may transmit Layer 1, Layer 2, or Layer 3 information that indicates the duration of the DTX cycle or the duration of the DTX cycle period. In some aspects, the information that indicates the duration of the DTX cycle or the duration of the DTX cycle period may be included in RRC information.

In some aspects, the UE 120 may transmit an indication of one or more tasks that the UE 120 is capable of performing during the active DTX cycle period. The network node 605 may determine which task the UE 120 should perform based at least in part on this information. In some aspects, the indication of the one or more tasks that the UE 120 is capable of performing may transmitted using Layer 1, Layer 2, or Layer 3 information. In some aspects, the indication of the one or more tasks that the UE 120 is capable of performing may be transmitted during a previous active DTX cycle period (e.g., for a next active DTX cycle period). In some aspects, the indication of the one or more tasks that the UE 120 is capable of performing may be transmitted during an inactive DTX cycle period.

In some aspects, the UE 120 may transmit an indication of an energy level (e.g., a battery status) associated with the UE 120. The network node 605 and/or the UE 120 may determine one or more tasks that the UE 120 is capable of performing based at least in part on the energy level of the UE 120.

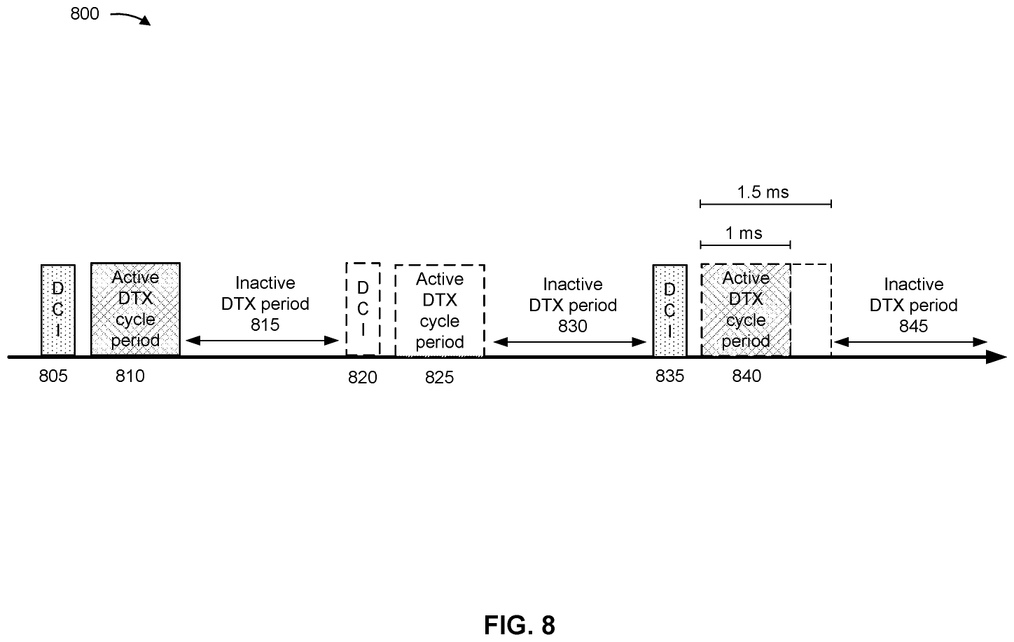

In some aspects, the wake-up indication may be received prior to the active DTX cycle period during which the UE 120 is to perform the transmission. For example, the wake-up indication may be received during another active DTX cycle period or during an inactive DTX cycle period. In some aspects, the UE 120 may be configured to extend a duration of an active DTX cycle period. Additional details regarding these features are described in connection with FIG. 8.

In some aspects, the UE 120 may default to an inactive state. For example, the UE 120 may default to the inactive state during the one or more DTX cycle periods, unless the UE 120 receives the wake-up indication. Thus, the UE 120 may be in the inactive state by default, but the UE 120 may enter the active state for a DTX cycle period based at least in part on receiving a wake-up indication for the DTX cycle period. In some aspects, the UE 120 may default to the active state. For example, the UE 120 may default to the active state during the one or more DTX cycle periods, unless the UE 120 receives a sleep indication. Thus, the UE 120 may be in the active state by default, but the UE 120 may enter the inactive state for a DTX cycle period based at least in part on receiving a sleep indication for the DTX cycle period.

In some aspects, the UE 120 may not expect to receive any radio link (e.g., uplink) or sidelink grants during the inactive DTX cycle period. For example, the UE 120 may not expect to receive any radio link or sidelink grants during the inactive DTX cycle period for performing the scheduling, the energy transfer, or the relaying. In some aspects, the UE 120 may not decode a radio link or sidelink grant that is received during the inactive DTX cycle period.

In some aspects, the network node 605 may transmit one or more parameters associated with the transmission. For example, the network node 605 may transmit, and the UE 120 may receive, one or more parameters for the scheduling, one or more parameters for the energy transfer, and/or one or more parameters for the relaying.

In some aspects, the one or more parameters for the relaying (e.g., PC5 or Uu relaying) may include a transmit power configuration or parameter, a buffer requirement for the relaying, a maximum number of transmit ports or bandwidth parts for the data transmission, a maximum bandwidth for the data transmission, a number of packets that are being relayed, and/or a duplex mode indication. In some aspects, the duplex mode indication may indicate whether time division duplexing (TDD) (either half-duplex (HD) or full-duplex (FD)) or frequency division duplexing (FDD) (either HD or FD) is to be used. In some aspects, the duplex mode indication may indicate a time occasion (e.g., a time domain (TD) pattern) for performing the transmission or reception.

In some aspects, the one or more parameters for the energy transfer (e.g., PC5 or Uu energy transfer) may include a required charging rate, a transmit power configuration or parameter, a type of casting (e.g., unicast, groupcast, or broadcast), a maximum number of transmit ports or bandwidth parts for the energy transfer, configured grants for the energy transfer, dynamic grants for the energy transfer, a band of operation for transmitting the energy, a duplex mode indication, or an expected number of energy transmissions or occasions. In some aspects, the type of casting may be based on a configuration, such as a higher layer configuration, and the UE 120 may perform the energy transfer in accordance with the configuration. In some aspects, indicating the band of operation for transmitting the energy may include indicating a component carrier or a bandwidth part and may be used for adjusting the transmission filters across the active DTX cycle period to avoid a switching power loss. In some aspects, the duplex mode indication may indicate whether TDD (either HD or FD) or FDD (either HD or FD) is to be used. In some aspects, the duplex mode indication may indicate a time occasion (e.g., a TD pattern) for performing the energy transfer.

In some aspects, the network node 605 may indicate the type of transmission to be performed for a DTX cycle. For example, the wake-up indication may indicate whether the UE 120 should perform the scheduling, energy transfer, and/or relaying for the DTX cycle. In some aspects, different transmissions may be scheduled for different DTX cycles. For example, a wake-up indication may indicate for the UE 120 to perform scheduling during a first active DTX cycle period, and a wake-up indication (e.g., the same wake-up indication or a different wake-up indication) may indicate for the UE 120 to perform energy transfer during a second active DTX cycle period. In some aspects, the network node 605 may indicate the cost (e.g., the amount of energy) for performing the transmission (e.g., the scheduling, energy transfer, or relaying), and/or may indicate a QoS associated with the transmission or a number of resources that are needed for the transmission.

In some aspects, the UE 120 may be configured with one or more DTX cycle configurations. For example, the UE 120 may be configured with a first DTX cycle configuration (e.g., a default configuration) and may receive a second DTX cycle configuration from the network node 605. In some aspects the UE 120 may not be able to decode the wake-up indication from the network node 605, and the UE 120 may enter an active state (e.g., to perform a transmission) or may enter an inactive state (e.g., to conserve energy) in accordance with a selected one of the configurations. In some aspects, the first DTX cycle configuration may indicate for the UE 120 to perform a first type of transmission, and the second DTX configuration may indicate for the UE 120 to perform a second type of transmission. In some aspects, the UE 120 may transmit, to the network node 605, an indication of which configuration the UE 120 is going to use. For example, the UE 120 may indicate that the UE 120 will use the second configuration, and thus will enter the inactive state (or remain in an inactive state) based at least in part on not being able to decode the wake-up indication. In some aspects, the network node 605 and/or the UE 120 may indicate whether sidelink (PC5) or radio link (Uu) transmissions will be performed.

In some aspects, the network node 605 may indicate for the UE 120 to transmit an acknowledgement message (e.g., a HARQ acknowledgement message (HARQ-ACK)) or a negative acknowledgement message (e.g., a HARQ negative acknowledgement message (HARQ-NACK)) based at least in part on receiving the wake-up indication. In some aspects, the UE 120 may transmit the HARQ-ACK based at least in part on receiving the wake-up indication and based at least in part on determining to perform the transmission. In some aspects, the UE 120 may transmit the HARQ-NACK based at least in part on not being able to decode the wake-up indication or based at least in part on determining that the UE 120 will not perform the transmission. In some aspects, the UE 120 may transmit an indication of which transmission, of a plurality of transmissions requested by the network node 605, that the UE 120 is capable of performing (or will perform). For example, the UE 120 may transmit an indication that the UE 120 will perform the relaying but that the UE 120 will not perform the energy transfer.

In some aspects, the network node 605 may indicate a QoS associated with the transmission. For example, the network node 605 may indicate a QoS associated with the scheduling, energy transfer, or relaying. The QoS may be indicated using Layer 1 signaling (e.g., DCI), Layer 2 signaling (e.g., MAC information such as a MAC control element (MAC-CE)), or Layer 3 signaling (e.g., RRC information), or in the wake-up indication. The UE 120 may be configured to accept the QoS or negotiate the QoS with the network node 605.

In some aspects, the UE 120 may schedule a transmission by another UE via sidelink. In some aspects, the UE 120 may obtain DTX cycle information associated with the other UE 705. For example, the UE 120 may receive a sidelink communication from the other UE 705 that includes the DTX cycle information associated with the other UE 705. The UE 120 may schedule a transmission by the other UE 705 based at least in part on the DTX cycle information associated with the other UE 705. For example, the UE 120 may transmit a sidelink communication to the other UE 705 that includes scheduling information. The scheduling information may indicate for the other UE 705 to perform a transmission during an active DTX cycle period associated with the other UE 705. The other UE 705 may receive the scheduling information from the UE 120 via the sidelink communication, and may perform a transmission during an active DTX cycle period based at least in part on the scheduling information.

In some aspects, the UE 120 may transmit energy signals to one or more passive IoT devices. For example, the UE 120 may transmit energy signals to one or more RF energy harvesting devices. Additionally, or alternatively, the UE 120 may operate as an RF source for a tag (e.g., a radio frequency identification (RFID) tag). In some aspects, the energy signals may be used for powering, charging, and/or operating an integrated circuit associated with the tag. The UE 120 may transmit the energy signals (e.g., operate as the RF source) to enable information associated with the tag to be sent as commands or queries. Additionally, or alternatively, the energy signals may enable a tag that uses backscattering techniques to be read using the power provided by the energy signals.

In some aspects, the UE 120 may participate in relaying. In some aspects, the UE 120 may relay information from the network node 605 to another UE, such as the other UE 705. For example, the UE 120 may relay scheduling information and/or energy transfer information from the network node 605 to the other UE 705. In some aspects, the UE 120 may relay information from one UE to another UE. For example, the UE 120 may relay scheduling information and/or energy transfer information from a first other UE 705 to a second other UE 705.

In some aspects, the UE 120 may perform two or more of the sidelink scheduling, energy signal transmission, and relaying operations described above. For example, the UE 120 may be configured to perform a sidelink scheduling operation and an energy signal transmission operation, a sidelink scheduling operation and a relaying operation, an energy signal transmission operation and a relaying operation, or all three of the sidelink scheduling, energy signal transmission, and relaying operations, among other examples.

In some aspects, the UE 120 may be configured with a plurality of DTX configurations. Each DTX configuration may be associated with a time duration for active DTX and inactive DTX. For example, a first DTX configuration may have a first time duration for active DTX and inactive DTX, and a second DTX configuration may have a second time duration for active DTX and inactive DTX. In some aspects, each DTX configuration may be configured with one or more WUS monitoring occasions for receiving an indication to wakeup during a DTX active time. In some aspects, a DTX configuration may be associated with one or more of the operations described above. For example, a first DTX configuration may be associated with a sidelink scheduling operation, a second DTX configuration may be configured with an energy signal transmission operation, and a third DTX configuration may be associated with a relaying operation. The UE 120 may be configured with one or more DTX configurations. For example, the UE 120 may be configured with one or more DTX configurations (e.g., one or more DTX configuration types) based at least in part on one or more capabilities of the UE 120.

In some aspects, a set of UEs (such as energy harvesting UEs or sidelink UEs), a class of UEs, a set of tags, or a class of tags may be associated with one or more DTX configurations. For example, a first type of UE or tag (such as an energy harvesting UE) may be configured with a first DTX configuration and a second type of UE or tag (such as an RFID tag) may be configured with a second DTX configuration. The UE 120 may transmit information to the first type of UE or tag or the second type of UE or tag based at least in part on the configuration associated with the first type of UE or tag and the second type of UE or tag, respectively.

As shown in connection with reference number 720, the UE 120 may perform the transmission. For example, the UE 120 may transmit, and the other UE 705 may receive, the transmission. The transmission may be, or may include, a sidelink scheduling transmission, a sidelink energy transfer transmission, a sidelink relaying transmission, a radio link scheduling transmission, a radio link energy transfer transmission, and/or a radio link relaying transmission.

In some aspects, performing the sidelink scheduling transmission may include scheduling one or more communications associated with the other UE 705 (e.g., between the UE 120 and the other UE 705). In some aspects, performing the sidelink energy transfer transmission may include transferring energy (e.g., power signals) to the other UE 705. In some aspects, performing the sidelink relaying transmission may include relaying one or more communications to the other UE 705. In some aspects, performing the radio link scheduling transmission may include scheduling one or more communications associated with the network node 605 (e.g., between the UE 120 and the network node 605). In some aspects, performing the radio link energy transfer transmission may include transferring energy (e.g., power signals) to the network node 605. In some aspects, performing the radio link relaying transmission may include relaying one or more communications to the network node 605.

As described herein, the network node 605 may not be configured with DTX cycle information associated with the UE 120 performing transmissions, such as scheduling, energy transfer, or relaying. This may result in disrupted energy saving capabilities and/or interfering communications. Using the techniques and apparatuses described herein, the UE 120 may transmit DTX cycle information to the network node 605 that indicates one or more active DTX cycle periods and one or more inactive DTX cycle periods. This may enable the network node 605 to schedule the UE 120 to perform the transmissions during the one or more active DTX cycle periods, and not during the one or more inactive DTX cycle periods. Accordingly, energy saving capabilities of the UE 120 may be improved, and the likelihood of interfering communications may be reduced.

As indicated above, FIG. 7 is provided as an example. Other examples may differ from what is described with respect to FIG. 7.

FIG. 8 is a diagram illustrating an example 800 of DTX cycle periods, in accordance with the present disclosure. A DTX cycle may include a plurality of DTX cycle periods. For example, the DTX cycle may include a first DTX cycle period that includes a DCI 805 portion, an active DTX cycle period 810, and an inactive DTX cycle period 815. The DCI 805 portion may be used by the UE 120 for receiving DCI (e.g., from the network node 605) that includes instructions for performing sidelink transmissions. The active DTX cycle period 810 may indicate a period of time at which the UE 120 may perform transmissions, such as sidelink scheduling transmissions, sidelink energy transfer transmissions, or sidelink relaying transmissions, among other examples. The inactive DTX cycle period 815 may indicate a period of time at which the UE 120 may not perform the transmissions. While the example 800 is described in terms of sidelink transmissions (e.g., via the PC5 interface), the example 800 may also be applied for radio link transmissions (e.g., via the Uu interface).

In some aspects, the DCI 805 may indicate for the UE 120 to perform a first sidelink transmission during the active DTX cycle period 810. For example, the DCI 805 may indicate for the UE 120 to perform sidelink scheduling during the first active DTX cycle period 810. The UE 120 may be configured to perform the sidelink scheduling (as described above in connection with FIG. 7) during the active DTX cycle period 810. At the end of the active DTX cycle period 810, the UE 120 may enter an inactive state (e.g., a sleep state) of the UE 120.

In some aspects, a second DTX cycle period of the DTX cycle may include a DCI portion 820, an active DTX cycle period 825, and an inactive DTX cycle period 830. In this case, the UE 120 may not receive instructions from the network node 605, during the DCI portion 820, for performing sidelink transmissions. Thus, the UE 120 may not perform the sidelink transmissions during the active DTX cycle period 825. Instead, the UE 120 may operate according to a default configuration of the UE 120 (or a configuration received from the network node 605). For example, the UE 120 may default to an active state for performing other communications, or the UE 120 may default to an inactive state for energy conservation, based at least in part on the configuration. The UE 120 may switch to the inactive state, or remain in the inactive state, for the inactive DTX cycle period 830.

In some aspects, a third DTX cycle period of the DTX cycle may include a DCI portion 835, an active DTX cycle period 840, and an inactive DTX cycle period 845. In this case, the UE 120 may receive DCI from the network node 605 that indicates for the UE 120 to perform a sidelink transmission. The DCI may indicate for the UE 120 to perform the same type of sidelink transmission as in the first DTX cycle period, or to perform a different type of sidelink transmission than in the second DTX cycle period, such as to perform sidelink energy transfer. In this case, the UE 120 may perform the sidelink transmission (e.g., the sidelink energy transfer) during the active DTX cycle period 840 and may enter the inactive DTX cycle period 845 at an end of the active DTX cycle period 840.

In some aspects, the UE 120 may transmit an indication to the network node 605, or the network node 605 may transmit an indication to the UE 120, to extend a duration of an active DTX cycle period. For example, the UE 120 or the network node 605 may indicate to extend the duration of the active DTX cycle period from 1 millisecond (ms) to 1.5 ms. Thus, the UE 120 may perform the transmission (e.g., sidelink relaying) for a period of 1.5 ms (during the active DTX cycle period 840). In this case, the active DTX cycle period 840 may extend into the inactive DTX cycle period 845. The UE 120 may enter the inactive DTX cycle period 845 at an end of the extended active DTX cycle period 840 (e.g., after an expiration of the 1.5 ms).

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with DTX cycle communication scheduling.

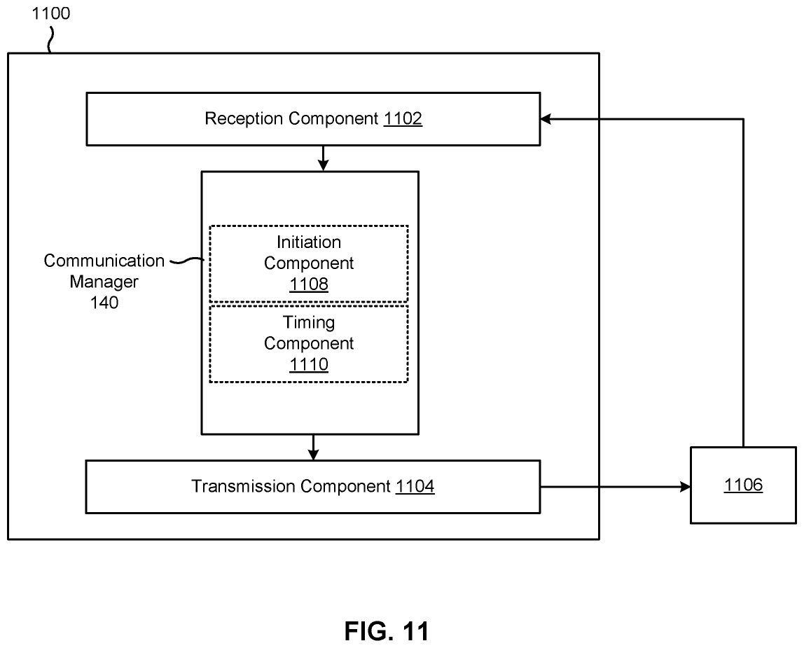

As shown in FIG. 9, in some aspects, process 900 may include receiving a wake-up indication, for a DTX cycle period, that indicates to perform a transmission associated with at least one of scheduling, energy transfer, or relaying (block 910). For example, the UE (e.g., using communication manager 140 and/or reception component 1102, depicted in FIG. 11) may receive a wake-up indication, for a DTX cycle period, that indicates to perform a transmission associated with at least one of scheduling, energy transfer, or relaying, as described above.

As further shown in FIG. 9, in some aspects, process 900 may include performing the transmission during the DTX cycle period (block 920). For example, the UE (e.g., using communication manager 140 and/or transmission component 1104, depicted in FIG. 11) may perform the transmission during the DTX cycle period, as described above.

Process 900 may include additional aspects, such as any single aspect or any combination of aspects described below and/or in connection with one or more other processes described elsewhere herein.

In a first aspect, process 900 includes transmitting configuration information that indicates one or more active DTX cycle periods for the UE and one or more inactive DTX cycle periods for the UE.

In a second aspect, alone or in combination with the first aspect, the configuration information indicates that the UE can perform the scheduling, energy transfer, or relaying during the one or more active DTX cycle periods, and that the UE cannot perform the scheduling, energy transfer, or relaying during the one or more inactive DTX cycle periods.

In a third aspect, alone or in combination with one or more of the first and second aspects, process 900 includes initiating, by default, an inactive state of the UE, and initiating an active state of the UE, for an active DTX cycle period, based at least in part on receiving the wake-up indication.

In a fourth aspect, alone or in combination with one or more of the first through third aspects, process 900 includes initiating, by default, an active state of the UE, and initiating an inactive state of the UE, for an inactive DTX cycle period, based at least in part on receiving a sleep indication.

In a fifth aspect, alone or in combination with one or more of the first through fourth aspects, receiving the wake-up indication comprises receiving, from a network node, downlink control information that includes the wake-up indication.

In a sixth aspect, alone or in combination with one or more of the first through fifth aspects, the wake-up indication includes one or more scheduling parameters, one or more energy transfer parameters, or one or more relaying parameters.

In a seventh aspect, alone or in combination with one or more of the first through sixth aspects, the one or more relaying parameters comprise a transmit power configuration or parameter, a buffer requirement, a maximum number of transmission ports, a maximum number of bandwidth parts for data transmission, a number of packets to be relayed, an indication of a duplex mode, or an indication of a time domain pattern.

In an eighth aspect, alone or in combination with one or more of the first through seventh aspects, the one or more energy transfer parameters comprise a required charging rate, a transmit power configuration or parameter, a casting indication, a maximum number of transmission ports, a maximum number of bandwidth parts for energy transfer, a configured grant or a dynamic grant for the energy transfer, a band of operation for performing the energy transfer, an indication of a duplex mode, or a number of expected energy transmissions or occasions.

In a ninth aspect, alone or in combination with one or more of the first through eighth aspects, the wake-up indication indicates which of the scheduling, energy transfer, or relaying is to be performed.

In a tenth aspect, alone or in combination with one or more of the first through ninth aspects, the wake-up indication indicates a quality of service or a number of resources that are required for performing the scheduling, energy transfer, or relaying.

In an eleventh aspect, alone or in combination with one or more of the first through tenth aspects, process 900 includes initiating an active state of the UE or an inactive state of the UE, according to a default configuration or a configuration received from a network node, based at least in part on not being able to decode the wake-up indication.

In a twelfth aspect, alone or in combination with one or more of the first through eleventh aspects, process 900 includes transmitting, to the network node, an indication of whether the UE will use the default configuration or the configuration received from the network node.

In a thirteenth aspect, alone or in combination with one or more of the first through twelfth aspects, process 900 includes extending a duration of the DTX cycle period, wherein the DTX cycle period is an active DTX cycle period.

In a fourteenth aspect, alone or in combination with one or more of the first through thirteenth aspects, process 900 includes receiving, from a network node, an indication to extend the duration of the active DTX cycle period, or transmitting, to the network node, an indication that the active DTX cycle period is to be extended.

In a fifteenth aspect, alone or in combination with one or more of the first through fourteenth aspects, process 900 includes transmitting an acknowledgement message or a negative acknowledgement message based at least in part on receiving the wake-up indication.

In a sixteenth aspect, alone or in combination with one or more of the first through fifteenth aspects, process 900 includes transmitting an indication of whether the UE is capable of performing the scheduling, energy transfer, or relaying.

In a seventeenth aspect, alone or in combination with one or more of the first through sixteenth aspects, the wake-up indication that indicates to perform the transmission is a wake-up indication that indicates to perform a transmission associated with at least one of sidelink scheduling, sidelink energy transfer, or sidelink relaying.

In an eighteenth aspect, alone or in combination with one or more of the first through seventeenth aspects, the wake-up indication that indicates to perform the transmission is a wake-up indication that indicates to perform a transmission associated with at least one of radio link scheduling, radio link energy transfer, or radio link relaying.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 605) performs operations associated with DTX cycle communication scheduling. In some aspects, the network node may include some or all of the features of the base station 110, the CU 310, the DU 330, and/or the RU 340.

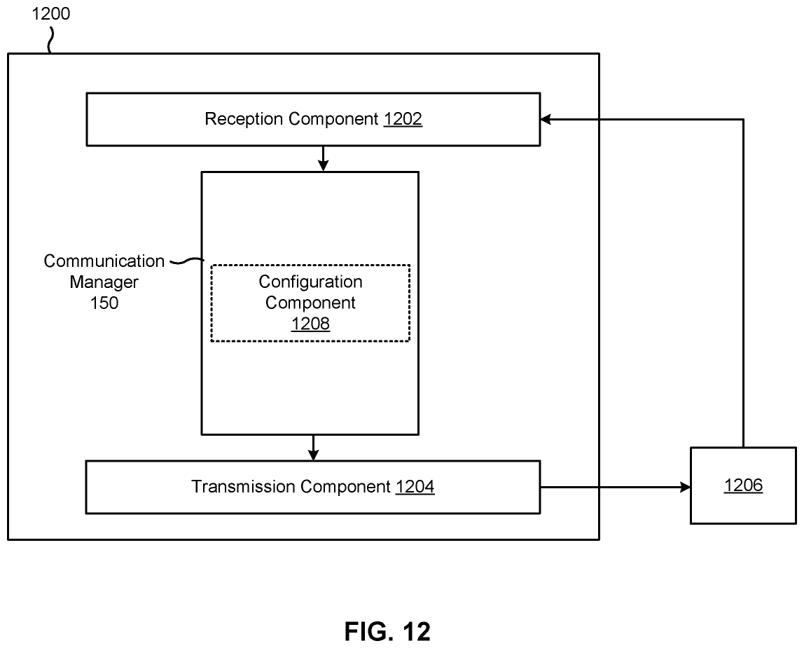

As shown in FIG. 10, in some aspects, process 1000 may include receiving DTX cycle information from a UE that indicates one or more active DTX cycle periods and one or more inactive DTX cycle periods (block 1010). For example, the network node (e.g., using communication manager 150 and/or reception component 1202, depicted in FIG. 12) may receive DTX cycle information from a UE that indicates one or more active DTX cycle periods and one or more inactive DTX cycle periods, as described above.

As further shown in FIG. 10, in some aspects, process 1000 may include transmitting a wake-up indication, for an active DTX cycle period of the one or more active DTX cycle periods, that indicates for the UE to perform a transmission associated with at least one of scheduling, energy transfer, or relaying (block 1020). For example, the network node (e.g., using communication manager 150 and/or transmission component 1204, depicted in FIG. 12) may transmit a wake-up indication, for an active DTX cycle period of the one or more active DTX cycle periods, that indicates for the UE to perform a transmission associated with at least one of scheduling, energy transfer, or relaying, as described above.

Process 1000 may include additional aspects, such as any single aspect or any combination of aspects described below and/or in connection with one or more other processes described elsewhere herein.

In a first aspect, the DTX cycle information indicates that the UE can perform the scheduling, energy transfer, or relaying during the one or more active DTX cycle periods, and that the UE cannot perform the scheduling, energy transfer, or relaying during the one or more inactive DTX cycle periods.

In a second aspect, alone or in combination with the first aspect, transmitting the wake-up indication comprises transmitting downlink control information that includes the wake-up indication.

In a third aspect, alone or in combination with one or more of the first and second aspects, the wake-up indication includes one or more scheduling parameters, one or more energy transfer parameters, or one or more relaying parameters.

In a fourth aspect, alone or in combination with one or more of the first through third aspects, the one or more relaying parameters comprise a transmit power configuration or parameter, a buffer requirement, a maximum number of transmission ports, a maximum number of bandwidth parts for data transmission, a number of packets to be relayed, an indication of a duplex mode, or an indication of a time domain pattern.

In a fifth aspect, alone or in combination with one or more of the first through fourth aspects, the one or more energy transfer parameters comprise a required charging rate, a transmit power configuration or parameter, a casting indication, a maximum number of transmission ports, a maximum number of bandwidth parts for energy transfer, a configured grant or a dynamic grant for the energy transfer, a band of operation for performing the energy transfer, an indication of a duplex mode, or a number of expected energy transmissions or occasions.

In a sixth aspect, alone or in combination with one or more of the first through fifth aspects, the wake-up indication indicates which of the scheduling, energy transfer, or relaying is to be performed by the UE.

In a seventh aspect, alone or in combination with one or more of the first through sixth aspects, the wake-up indication indicates a quality of service or a number of resources that are required for performing the scheduling, energy transfer, or relaying.

In an eighth aspect, alone or in combination with one or more of the first through seventh aspects, process 1000 includes transmitting an indication for the UE to extend a duration of the active DTX cycle period.

In a ninth aspect, alone or in combination with one or more of the first through eighth aspects, process 1000 includes receiving an acknowledgement message or a negative acknowledgement message based at least in part on transmitting the wake-up indication.

In a tenth aspect, alone or in combination with one or more of the first through ninth aspects, process 1000 includes receiving an indication of whether the UE is capable of performing the scheduling, energy transfer, or relaying.

In an eleventh aspect, alone or in combination with one or more of the first through tenth aspects, the wake-up indication that indicates to perform the transmission is a wake-up indication that indicates to perform a transmission associated with at least one of sidelink scheduling, sidelink energy transfer, or sidelink relaying.

In a twelfth aspect, alone or in combination with one or more of the first through eleventh aspects, the wake-up indication that indicates to perform the transmission is a wake-up indication that indicates to perform a transmission associated with at least one of radio link scheduling, radio link energy transfer, or radio link relaying.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of an initiation component 1108 or a timing component 1110, among other examples.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive a wake-up indication, for a DTX cycle period, that indicates to perform a transmission associated with at least one of scheduling, energy transfer, or relaying. The transmission component 1104 may perform the transmission during the DTX cycle period.

The transmission component 1104 may transmit configuration information that indicates one or more active DTX cycle periods for the UE and one or more inactive DTX cycle periods for the UE.

The initiation component 1108 may initiate, by default, an inactive state of the UE. The initiation component 1108 may initiate an active state of the UE, for an active DTX cycle period, based at least in part on receiving the wake-up indication. The initiation component 1108 may initiate, by default, an active state of the UE. The initiation component 1108 may initiate an inactive state of the UE, for an inactive DTX cycle period, based at least in part on receiving a sleep indication. The initiation component 1108 may initiate an active state of the UE or an inactive state of the UE, according to a default configuration or a configuration received from a network node, based at least in part on not being able to decode the wake-up indication.

The transmission component 1104 may transmit, to the network node, an indication of whether the UE will use the default configuration or the configuration received from the network node.

The timing component 1110 may extend a duration of the DTX cycle period, wherein the DTX cycle period is an active DTX cycle period. The reception component 1102 may receive, from a network node, an indication to extend the duration of the active DTX cycle period. The transmission component 1104 may transmit, to the network node, an indication that the active DTX cycle period is to be extended.

The transmission component 1104 may transmit an acknowledgement message or a negative acknowledgement message based at least in part on receiving the wake-up indication.

The transmission component 1104 may transmit an indication of whether the UE is capable of performing the scheduling, energy transfer, or relaying.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The reception component 1202 may receive DTX cycle information from a UE that indicates one or more active DTX cycle periods and one or more inactive DTX cycle periods. The transmission component 1204 may transmit a wake-up indication, for an active DTX cycle period of the one or more active DTX cycle periods, that indicates for the UE to perform a transmission associated with at least one of scheduling, energy transfer, or relaying.

The transmission component 1204 may transmit an indication for the UE to extend a duration of the active DTX cycle period. The reception component 1202 may receive an acknowledgement message or a negative acknowledgement message based at least in part on transmitting the wake-up indication.

The reception component 1202 may receive an indication of whether the UE is capable of performing the scheduling, energy transfer, or relaying. The configuration component 1208 may obtain configuration information that indicates whether the UE is capable of performing the scheduling, energy transfer, or relaying.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving a wake-up indication, for a discontinuous transmission (DTX) cycle period, that indicates to perform a transmission associated with at least one of scheduling, energy transfer, or relaying; and performing the transmission during the DTX cycle period.

Aspect 2: The method of Aspect 1, further comprising transmitting configuration information that indicates one or more active DTX cycle periods for the UE and one or more inactive DTX cycle periods for the UE.

Aspect 3: The method of Aspect 2, wherein the configuration information indicates that the UE can perform the scheduling, energy transfer, or relaying during the one or more active DTX cycle periods, and that the UE cannot perform the scheduling, energy transfer, or relaying during the one or more inactive DTX cycle periods.

Aspect 4: The method of any of Aspects 1-3, further comprising: initiating, by default, an inactive state of the UE; and initiating an active state of the UE, for an active DTX cycle period, based at least in part on receiving the wake-up indication.

Aspect 5: The method of any of Aspects 1-4, further comprising: initiating, by default, an active state of the UE; and initiating an inactive state of the UE, for an inactive DTX cycle period, based at least in part on receiving a sleep indication.

Aspect 6: The method of any of Aspects 1-5, wherein receiving the wake-up indication comprises receiving, from a network node, downlink control information that includes the wake-up indication.

Aspect 7: The method of any of Aspects 1-6, wherein the wake-up indication includes one or more scheduling parameters, one or more energy transfer parameters, or one or more relaying parameters.

Aspect 8: The method of Aspect 7, wherein the one or more relaying parameters comprise a transmit power configuration or parameter, a buffer requirement, a maximum number of transmission ports, a maximum number of bandwidth parts for data transmission, a number of packets to be relayed, an indication of a duplex mode, or an indication of a time domain pattern.

Aspect 9: The method of Aspect 7, wherein the one or more energy transfer parameters comprise a required charging rate, a transmit power configuration or parameter, a casting indication, a maximum number of transmission ports, a maximum number of bandwidth parts for energy transfer, a configured grant or a dynamic grant for the energy transfer, a band of operation for performing the energy transfer, an indication of a duplex mode, or a number of expected energy transmissions or occasions.

Aspect 10: The method of any of Aspects 1-9, wherein the wake-up indication indicates which of the scheduling, energy transfer, or relaying is to be performed.

Aspect 11: The method of any of Aspects 1-10, wherein the wake-up indication indicates a quality of service or a number of resources that are required for performing the scheduling, energy transfer, or relaying.

Aspect 12: The method of any of Aspects 1-11, further comprising initiating an active state of the UE or an inactive state of the UE, according to a default configuration or a configuration received from a network node, based at least in part on not being able to decode the wake-up indication.

Aspect 13: The method of Aspect 12, further comprising transmitting, to the network node, an indication of whether the UE will use the default configuration or the configuration received from the network node.

Aspect 14: The method of any of Aspects 1-13, further comprising extending a duration of the DTX cycle period, wherein the DTX cycle period is an active DTX cycle period.

Aspect 15: The method of Aspect 14, further comprising: receiving, from a network node, an indication to extend the duration of the active DTX cycle period; or transmitting, to the network node, an indication that the active DTX cycle period is to be extended.

Aspect 16: The method of any of Aspects 1-15, further comprising transmitting an acknowledgement message or a negative acknowledgement message based at least in part on receiving the wake-up indication.

Aspect 17: The method of any of Aspects 1-16, further comprising transmitting an indication of whether the UE is capable of performing the scheduling, energy transfer, or relaying.

Aspect 18: The method of any of Aspects 1-17, wherein the wake-up indication that indicates to perform the transmission is a wake-up indication that indicates to perform a transmission associated with at least one of sidelink scheduling, sidelink energy transfer, or sidelink relaying.

Aspect 19: The method of any of Aspects 1-18, wherein the wake-up indication that indicates to perform the transmission is a wake-up indication that indicates to perform a transmission associated with at least one of radio link scheduling, radio link energy transfer, or radio link relaying.

Aspect 20: The method of any of Aspects 1-19, further comprising transmitting an indication of a duration of the DTX cycle period.

Aspect 21: The method of any of Aspects 1-20, further comprising transmitting an indication of one or more tasks that the UE is capable of performing during the DTX cycle period.

Aspect 22: The method of any of Aspects 1-21, further comprising transmitting an indication of an energy level associated with the UE.

Aspect 23: The method of any of Aspects 1-22, further comprising transmitting a sidelink communication to another UE that includes scheduling information, wherein the scheduling information indicates for the other UE to perform the transmission based at least in part on a schedule.

Aspect 24: The method of any of Aspects 1-23, further comprising transmitting an energy signal to an energy harvesting device.

Aspect 25: The method of any of Aspects 1-24, further comprising operating as a radio frequency source for a tag.

Aspect 26: The method of any of Aspects 1-25, wherein performing the transmission comprises relaying the transmission from a network node to another UE or from a first other UE to a second other UE.

Aspect 27: The method of any of Aspects 1-26, wherein the UE is configured with a plurality of DTX configurations.

Aspect 28: The method of Aspect 27, wherein each DTX configuration of the plurality of DTX configurations is associated with a time duration for active DTX and inactive DTX.

Aspect 29: A method of wireless communication performed by a network node, comprising: receiving discontinuous transmission (DTX) cycle information from a user equipment (UE) that indicates one or more active DTX cycle periods and one or more inactive DTX cycle periods; and transmitting a wake-up indication, for an active DTX cycle period of the one or more active DTX cycle periods, that indicates for the UE to perform a transmission associated with at least one of scheduling, energy transfer, or relaying.

Aspect 30: The method of Aspect 29, wherein the DTX cycle information indicates that the UE can perform the scheduling, energy transfer, or relaying during the one or more active DTX cycle periods, and that the UE cannot perform the scheduling, energy transfer, or relaying during the one or more inactive DTX cycle periods.

Aspect 31: The method of any of Aspects 29-30, wherein transmitting the wake-up indication comprises transmitting downlink control information that includes the wake-up indication.

Aspect 32: The method of any of Aspects 29-31, wherein the wake-up indication includes one or more scheduling parameters, one or more energy transfer parameters, or one or more relaying parameters.

Aspect 33: The method of Aspect 32, wherein the one or more relaying parameters comprise a transmit power configuration or parameter, a buffer requirement, a maximum number of transmission ports, a maximum number of bandwidth parts for data transmission, a number of packets to be relayed, an indication of a duplex mode, or an indication of a time domain pattern.

Aspect 34: The method of Aspect 32, wherein the one or more energy transfer parameters comprise a required charging rate, a transmit power configuration or parameter, a casting indication, a maximum number of transmission ports, a maximum number of bandwidth parts for energy transfer, a configured grant or a dynamic grant for the energy transfer, a band of operation for performing the energy transfer, an indication of a duplex mode, or a number of expected energy transmissions or occasions.

Aspect 35: The method of any of Aspects 29-34, wherein the wake-up indication indicates which of the scheduling, energy transfer, or relaying is to be performed by the UE.

Aspect 36: The method of any of Aspects 29-35, wherein the wake-up indication indicates a quality of service or a number of resources that are required for performing the scheduling, energy transfer, or relaying.

Aspect 37: The method of any of Aspects 29-36, further comprising transmitting an indication for the UE to extend a duration of the active DTX cycle period.

Aspect 38: The method of any of Aspects 29-37, further comprising receiving an acknowledgement message or a negative acknowledgement message based at least in part on transmitting the wake-up indication.

Aspect 39: The method of any of Aspects 29-38, further comprising receiving an indication of whether the UE is capable of performing the scheduling, energy transfer, or relaying.

Aspect 40: The method of any of Aspects 29-39, wherein the wake-up indication that indicates to perform the transmission is a wake-up indication that indicates to perform a transmission associated with at least one of sidelink scheduling, sidelink energy transfer, or sidelink relaying.

Aspect 41: The method of any of Aspects 29-40, wherein the wake-up indication that indicates to perform the transmission is a wake-up indication that indicates to perform a transmission associated with at least one of radio link scheduling, radio link energy transfer, or radio link relaying.

Aspect 42: The method of any of Aspects 29-41, further comprising transmitting an indication of a duration of the DTX cycle period.

Aspect 43: The method of any of Aspects 29-42, further comprising transmitting an indication of one or more tasks that the UE is capable of performing during the DTX cycle period.

Aspect 44: The method of any of Aspects 29-43, further comprising transmitting an indication of an energy level associated with the UE.

Aspect 45: An apparatus for wireless communication at a device, comprising a processor; memory coupled with the processor; and instructions stored in the memory and executable by the processor to cause the apparatus to perform the method of one or more of Aspects 1-28.

Aspect 46: A device for wireless communication, comprising a memory and one or more processors coupled to the memory, the one or more processors configured to perform the method of one or more of Aspects 1-28.

Aspect 47: An apparatus for wireless communication, comprising at least one means for performing the method of one or more of Aspects 1-28.

Aspect 48: A non-transitory computer-readable medium storing code for wireless communication, the code comprising instructions executable by a processor to perform the method of one or more of Aspects 1-28.

Aspect 49: A non-transitory computer-readable medium storing a set of instructions for wireless communication, the set of instructions comprising one or more instructions that, when executed by one or more processors of a device, cause the device to perform the method of one or more of Aspects 1-28.

Aspect 50: An apparatus for wireless communication at a device, comprising a processor; memory coupled with the processor; and instructions stored in the memory and executable by the processor to cause the apparatus to perform the method of one or more of Aspects 29-44.

Aspect 51: A device for wireless communication, comprising a memory and one or more processors coupled to the memory, the one or more processors configured to perform the method of one or more of Aspects 29-44.

Aspect 52: An apparatus for wireless communication, comprising at least one means for performing the method of one or more of Aspects 29-44.

Aspect 53: A non-transitory computer-readable medium storing code for wireless communication, the code comprising instructions executable by a processor to perform the method of one or more of Aspects 29-44.

Aspect 54: A non-transitory computer-readable medium storing a set of instructions for wireless communication, the set of instructions comprising one or more instructions that, when executed by one or more processors of a device, cause the device to perform the method of one or more of Aspects 29-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a wake-up indication, for a discontinuous transmission (DTX) cycle period, that indicates to perform a transmission associated with at least one of scheduling, energy transfer, or relaying; and
perform the transmission during the DTX cycle period.

2. The apparatus of claim 1, wherein the one or more processors are further configured to transmit configuration information that indicates one or more active DTX cycle periods for the UE and one or more inactive DTX cycle periods for the UE.

3. The apparatus of claim 2, wherein the configuration information indicates that the UE can perform the scheduling, energy transfer, or relaying during the one or more active DTX cycle periods, and that the UE cannot perform the scheduling, energy transfer, or relaying during the one or more inactive DTX cycle periods.

4. The apparatus of claim 1, wherein the one or more processors are further configured to:
initiate, by default, an inactive state of the UE; and
initiate an active state of the UE, for an active DTX cycle period, based at least in part on receiving the wake-up indication.

5. The apparatus of claim 1, wherein the one or more processors are further configured to:
initiate, by default, an active state of the UE; and
initiate an inactive state of the UE, for an inactive DTX cycle period, based at least in part on receiving a sleep indication.

6. The apparatus of claim 1, wherein the wake-up indication includes one or more scheduling parameters, one or more energy transfer parameters, or one or more relaying parameters.

7. The apparatus of claim 6, wherein the one or more relaying parameters comprise a transmit power configuration or parameter, a buffer requirement, a maximum number of transmission ports, a maximum number of bandwidth parts for data transmission, a number of packets to be relayed, an indication of a duplex mode, or an indication of a time domain pattern.

8. The apparatus of claim 6, wherein the one or more energy transfer parameters comprise a required charging rate, a transmit power configuration or parameter, a casting indication, a maximum number of transmission ports, a maximum number of bandwidth parts for energy transfer, a configured grant or a dynamic grant for the energy transfer, a band of operation for performing the energy transfer, an indication of a duplex mode, or a number of expected energy transmissions or occasions.

9. The apparatus of claim 1, wherein the wake-up indication indicates which of the scheduling, energy transfer, or relaying is to be performed.

10. The apparatus of claim 1, wherein the one or more processors are further configured to initiate an active state of the UE or an inactive state of the UE, according to a default configuration or a configuration received from a network node, based at least in part on not being able to decode the wake-up indication.

11. The apparatus of claim 10, wherein the one or more processors are further configured to transmit, to the network node, an indication of whether the UE will use the default configuration or the configuration received from the network node.

12. The apparatus of claim 1, wherein the one or more processors are further configured to extend a duration of the DTX cycle period, wherein the DTX cycle period is an active DTX cycle period.

13. The apparatus of claim 1, wherein the one or more processors are further configured to transmit an acknowledgement message or a negative acknowledgement message based at least in part on receiving the wake-up indication.

14. The apparatus of claim 1, wherein the one or more processors are further configured to transmit an indication of whether the UE is capable of performing the scheduling, energy transfer, or relaying.

15. The apparatus of claim 1, wherein the wake-up indication that indicates to perform the transmission is a wake-up indication that indicates to perform a transmission associated with at least one of sidelink scheduling, sidelink energy transfer, sidelink relaying, radio link scheduling, radio link energy transfer, or radio link relaying.

16. The apparatus of claim 1, wherein the one or more processors are further configured to transmit an indication of a duration of the DTX cycle period.

17. An apparatus for wireless communication at a network node, comprising:
a memory; and
one or more processors, coupled to the memory, configured to:
receive discontinuous transmission (DTX) cycle information from a user equipment (UE) that indicates one or more active DTX cycle periods and one or more inactive DTX cycle periods; and
transmit a wake-up indication, for an active DTX cycle period of the one or more active DTX cycle periods, that indicates for the UE to perform a transmission associated with at least one of scheduling, energy transfer, or relaying.

18. The apparatus of claim 17, wherein the DTX cycle information indicates that the UE can perform the scheduling, energy transfer, or relaying during the one or more active DTX cycle periods, and that the UE cannot perform the scheduling, energy transfer, or relaying during the one or more inactive DTX cycle periods.

19. The apparatus of claim 17, wherein the wake-up indication includes one or more scheduling parameters, one or more energy transfer parameters, or one or more relaying parameters.

20. The apparatus of claim 19, wherein the one or more relaying parameters comprise a transmit power configuration or parameter, a buffer requirement, a maximum number of transmission ports, a maximum number of bandwidth parts for data transmission, a number of packets to be relayed, an indication of a duplex mode, or an indication of a time domain pattern.

21. The apparatus of claim 19, wherein the one or more energy transfer parameters comprise a required charging rate, a transmit power configuration or parameter, a casting indication, a maximum number of transmission ports, a maximum number of bandwidth parts for energy transfer, a configured grant or a dynamic grant for the energy transfer, a band of operation for performing the energy transfer, an indication of a duplex mode, or a number of expected energy transmissions or occasions.

22. The apparatus of claim 17, wherein the wake-up indication indicates which of the scheduling, energy transfer, or relaying is to be performed by the UE.

23. The apparatus of claim 17, wherein the one or more processors are further configured to transmit an indication for the UE to extend a duration of the active DTX cycle period.

24. The apparatus of claim 17, wherein the one or more processors are further configured to receive an indication of whether the UE is capable of performing the scheduling, energy transfer, or relaying.

25. The apparatus of claim 17, wherein the wake-up indication that indicates to perform the transmission is a wake-up indication that indicates to perform a transmission associated with at least one of sidelink scheduling, sidelink energy transfer, sidelink relaying, radio link scheduling, radio link energy transfer, or radio link relaying.

26. The apparatus of claim 17, wherein the one or more processors are further configured to receive an indication of a duration of the DTX cycle period.

27. A method of wireless communication performed by a user equipment (UE), comprising:
receiving a wake-up indication, for a discontinuous transmission (DTX) cycle period, that indicates to perform a transmission associated with at least one of scheduling, energy transfer, or relaying; and
performing the transmission during the DTX cycle period.

28. The method of claim 27, further comprising transmitting configuration information that indicates one or more active DTX cycle periods for the UE and one or more inactive DTX cycle periods for the UE, wherein the configuration information indicates that the UE can perform the scheduling, energy transfer, or relaying during the one or more active DTX cycle periods, and that the UE cannot perform the scheduling, energy transfer, or relaying during the one or more inactive DTX cycle periods.

29. A method of wireless communication performed by a network node, comprising:
receiving discontinuous transmission (DTX) cycle information from a user equipment (UE) that indicates one or more active DTX cycle periods and one or more inactive DTX cycle periods; and
transmitting a wake-up indication, for an active DTX cycle period of the one or more active DTX cycle periods, that indicates for the UE to perform a transmission associated with at least one of scheduling, energy transfer, or relaying.

30. The method of claim 29, wherein the DTX cycle information indicates that the UE can perform the scheduling, energy transfer, or relaying during the one or more active DTX cycle periods, and that the UE cannot perform the scheduling, energy transfer, or relaying during the one or more inactive DTX cycle periods.
